(19) United States
(12) Patent Application Publication
(10) Pub. No.: US 2026/0269775 A1
(43) Pub. Date: Sep. 10, 2026

(54) RELEASABLY MOUNTABLE POWER MODULE

(71) Applicant: Zachary Alexander MCCUE, Curve Lake (CA)

(72) Inventor: Zachary Alexander MCCUE, Curve Lake (CA)

(21) Appl. No.: 19/167,578

(22) PCT Filed: Mar. 20, 2024
(86) PCT No.: PCT/CA2024/050336

§ 371 Date: Sep. 22, 2025

Related U.S. Application Data
(60) Provisional application No. 63/491,383, filed on Mar. 21, 2023.

(51) Int. Cl. H02S 30/10; H02S 20/32; H02S 40/32; H02S 40/34

(52) U.S. Cl. CPC H02S 30/10; H02S 20/32; H02S 40/32; H02S 40/34

(57) ABSTRACT

According to an aspect, the present disclosure provides for a power module for releasably mounting to a surface of a structure having a universal mounting element, the power module may include a mounting apparatus having a frame for securing a solar power supply thereto, and a locking mechanism configured for releasably coupling with the universal mounting element of the structure. Embodiments in accordance with the present disclosure may further provide an output of the power module to a system external to the structure, or to an electrical system of the structure itself.

### FIELD

The present disclosure relates generally to a modular power supply for a structure, and more particularly to a solar power module for shipping containers, and even more particular to a releasably mountable solar power module for shipping containers for use in providing power to an external system.

### BACKGROUND

Adopting solar energy has seen a proliferation of unused or underused surfaces accommodate permanent placements for solar panels, providing a glut of previously unrealized renewable energy. Continued increases in demand for energy, particularly renewable energy, provide cause to identify new platforms and uses for solar energy. Furthermore, as manufacturing costs for solar panels and solar arrays continue to decrease, demand for solar energy will not only continue to increase, but rather accelerate. It remains desirable therefore, to develop further improvements and advancements in relation to deploying solar energy systems including but not limited to improving mounting systems for solar panels, finding new use cases for solar energy, integrating solar energy into new and/or different systems, and/or identifying unconventional or otherwise untapped surfaces to exploit solar energy with, to overcome shortcomings of known techniques, and to provide additional advantages thereto.

This section is intended to introduce various aspects of the art, which may be associated with the present disclosure. This discussion is believed to assist in providing a framework to facilitate a better understanding of particular aspects of the present disclosure. Accordingly, it should be understood that this section should be read in this light, and not necessarily as admissions of prior art.

### BRIEF DESCRIPTION OF THE DRAWINGS

Embodiments of the present disclosure will now be described, by way of example only, with reference to the attached Figures.

FIG. 1A is a block diagram illustration of a top view of a power module mounted to a shipping container in accordance with an embodiment of the present disclosure.

FIG. 1B is a front elevation view of the power module mounted to a shipping container illustrated in FIG. 1A

FIG. 1C is block diagram illustration of a top view of an embodiment of the power module illustrated in FIG. 1A comprising a DC-DC converter boost.

FIG. 2A is an example embodiment of a locking element in accordance with the present disclosure.

FIG. 2B is an example embodiment of a mounting element in accordance with the present disclosure.

FIG. 3 is a block diagram illustration of a module power system having a plurality of power modules in accordance with an embodiment of the present disclosure.

FIG. 4 is a block diagram of an example computing device or system for implementing one or more systems, aspects, embodiments, methods, or operations of the present disclosure.

Throughout the drawings, sometimes only one or fewer than all of the instances of an element visible in the view are designated by a lead line and reference character, for the sake only of simplicity and to avoid clutter. It will be understood, however, that in such cases, in accordance with the corresponding description, that all other instances are likewise designated and encompasses by the corresponding description.

### DETAILED DESCRIPTION

The following are examples of a releasably mountable power module in accordance with the present disclosure.

According to an aspect, the present disclosure provides for a power module for mounting to a surface of a structure having a universal mounting element, the power module including a mounting apparatus having a frame for securing a solar power supply thereto, and a locking mechanism configured for releasably coupling with the universal mounting element of the structure.

In an example embodiment, the solar power supply comprises a plurality of solar panels.

In an example embodiment, the power module may further include an adjustable mechanical element for controlling an orientation of a solar panel, the mechanical element coupled to the frame of the mounting apparatus and a solar panel of the plurality of solar panels.

In an example embodiment, the mechanical element comprises a retractable arm pivotally mounted to the frame of the mounting apparatus, the retractable arm for adjusting a pitch of the solar panel relative to the frame of the mounting apparatus.

In an example embodiment, the mechanical element comprises a rotatable platform mounted to the frame of the mounting apparatus, the rotatable platform for adjusting a rotation of the solar panel relative to the frame of the mounting apparatus.

In an example embodiment, the power module may further include a solar tracker module for determining a position of the sun, the solar tracker module being configured to provide a control signal to to the mechanical element for adjusting the orientation of the solar panel.

In an example embodiment, the power module may further include a collision detection sensor in communication with the solar tracker module, the collision detection sensor configured for determining whether adjusting the orientation of the solar panel will result in a collision with another object.

In an example embodiment, the locking mechanism comprises a first locking element configured for releasably coupling with the universal mounting element of the structure.

In an example embodiment, the mounting apparatus comprises a plurality of the locking mechanism for releasably coupling the mounting apparatus to a corresponding plurality of the universal mounting element of the shipping container.

In an example embodiment, the mounting apparatus comprises a plurality of mounting elements for attaching with the locking mechanism.

In an example embodiment, the plurality of mounting elements are disposed on the mounting apparatus for mounting alignment with a reciprocal universal mounting element.

In an example embodiment, the locking mechanism comprises a second locking element for attaching the locking mechanism to the mounting apparatus.

In an example embodiment, the locking mechanism comprises a lever for actuating the locking mechanism between a locked disposition and an unlocked disposition.

In an example embodiment, the locking mechanism comprises a twist lock.

In an example embodiment, the universal mounting element comprises an ISO corner casting.

In an example embodiment, the power module may further include an electrical circuit for coupling an output of the power supply to a bus electrically coupled to an electrical system.

In an example embodiment, the power module comprises the bus.

In an example embodiment, the bus comprises a DC bus and the power module further comprises a unidirectional DC-DC converter coupled between the output of the power supply and the bus, the converter for boosting the output of the power supply to the bus.

In an example embodiment, the bus comprises an AC bus and the power module further comprises an inverter coupled between the output of the power supply and the bus.

In an example embodiment, the frame includes a plurality of rubber grommets in contact with the power supply for mitigating vibration.

In an example embodiment, the structure comprises a shipping container.

In an example embodiment, the electrical system comprises a propulsion system for use in transporting the shipping container.

According to an aspect, the present disclosure provides for a modular power system for a plurality of structures, the modular power system including a plurality of power modules in accordance with one or more embodiments of the present disclosure, and a common bus for electrically coupling the power modules, in series or parallel, to an external system of the plurality of structures.

Aspects in accordance with the present disclosure provide a modular power supply that exploits existing infrastructure. For example, certain structures, such as shipping containers, may include a universal mounting element, providing an opportunity to releasably couple a modular power unit to the universally adopted and known design of the mounting element without having to permanently affix the power supply to the structure on a bespoke basis. For example, a top surface of a shipping container, which includes universal ISO corner castings, provides a universal mounting element for releasably mounting a power supply from any such shipping container anywhere in the world. The power supply may further generate power throughout the multi-modal transportation cycle of the shipping container; or, for example, may generate power directly for the shipping container in accordance with its use, for example, for use as a storage facility, shelter, or house.

Embodiments as disclosed herein may provide for installing power modules comprising solar panels on a mounting apparatus which releasably couple with ISO corner castings on a top surface of a shipping container. The power module may thus generate power for use with a system coupled to the shipping container, for example, for use in supplying power throughout the multi-mode transportation cycle of the shipping container, providing power for example while the shipping container waits in port or at a facility, during marine transportation, during ground transportation such as on trucks and trains, and during other last mile modes for delivering the shipping container to a destination. The power module may output power and/or connect to an external system, such as a propulsion system used in the transportation of the shipping container, and may beneficially offset power consumption for example, by providing supplemental power to the propulsion system used for transporting the shipping container, thereby reducing fuel costs. Examples of systems for which a modular power supply in accordance with the present disclosure may provide power to or for include, but are not limited to: auxiliary and standby generators, power-grids, marine propulsion systems, rail locomotives including battery-electrical rail vehicles, overland trucks, internal combustion engines (ICE), hybrid engines, and electrical and/or battery engines.

Embodiments of modular power supply as disclosed herein may also serve as a source of power for a structure and its associated use, for example by providing power to a shipping container to support its use in providing shelter or housing. Embodiments of a modular power supply as disclosed herein may also act as a grid-tied element for supporting a power grid, such as a local power grid for a shipping or port facility, or for example, for a micro-grid, an islanded micro-grid or non-islanded micro-grid.

Advantageously, embodiments as disclosed herein leverage a modular design to exploit universal infrastructure for implementing releasably mountable power modules which have traditionally been installed as permanent fixtures. For example, shipping containers include ISO corner castings which can act as a universal mounting element for use in installing a power module to a top surface of a shipping container anywhere in the world. Embodiments of a power module in accordance with the present disclosure may thus provide a locking mechanism which exploits the known design of the universal ISO corner casting found on shipping containers, for use in releasably mounting a power module to the top surface of the shipping container. Thus, rather than installing a solar power module as a permanent fixture, embodiments in accordance with the present disclosure provide a mounting apparatus which can readily lock-to, and release-from, a universal mounting element, such as an ISO corner casting on a shipping container. Accordingly, embodiments as disclosed herein provide for simplified design, installation, and removal of a power module to-and-from structures having universal mounting elements, in addition to the benefits of providing power generation. Furthermore, systems in accordance with the present disclosure may further provide a plurality of releasably mountable power modules on a corresponding plurality of structures and further provide the collective output of each power module to an external system.

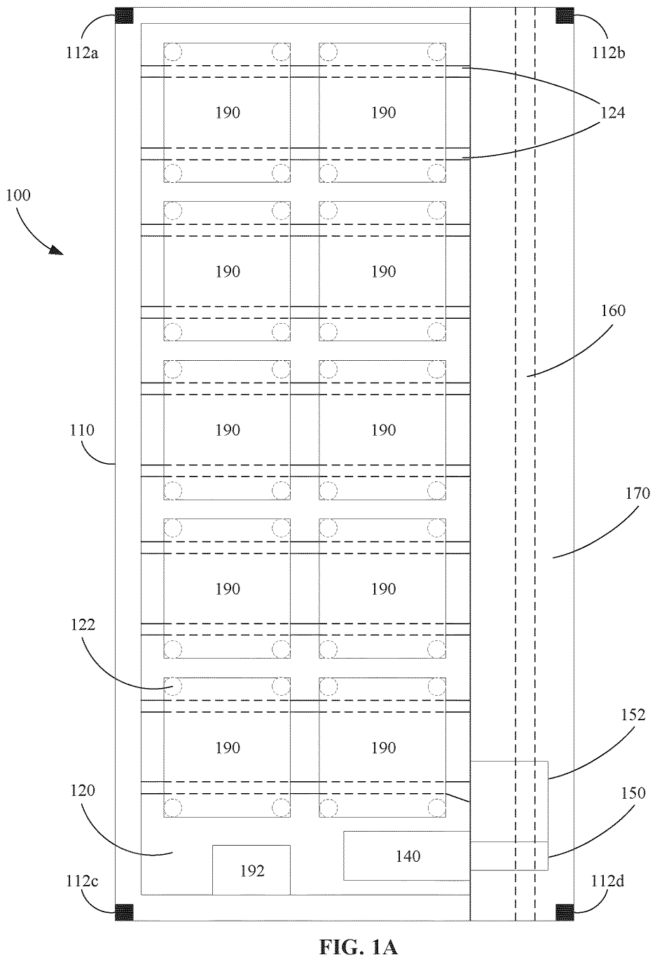

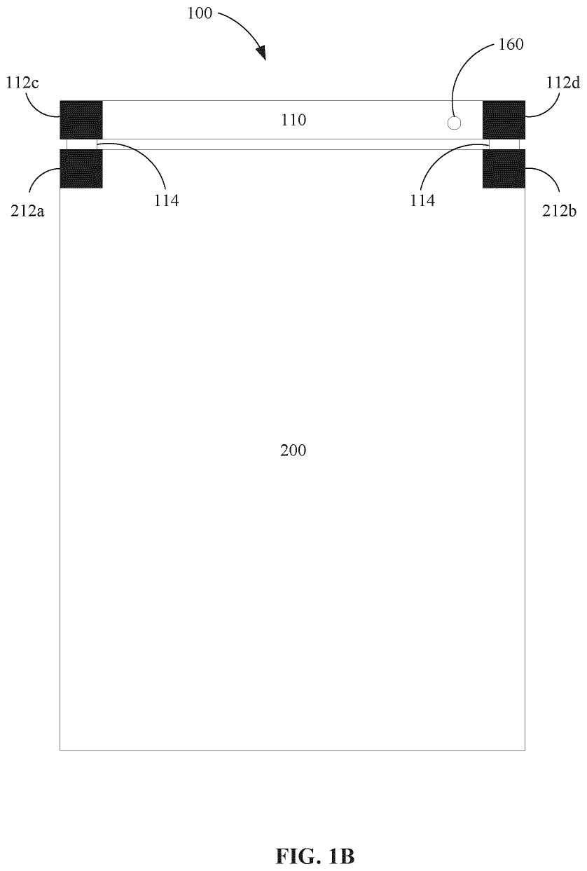

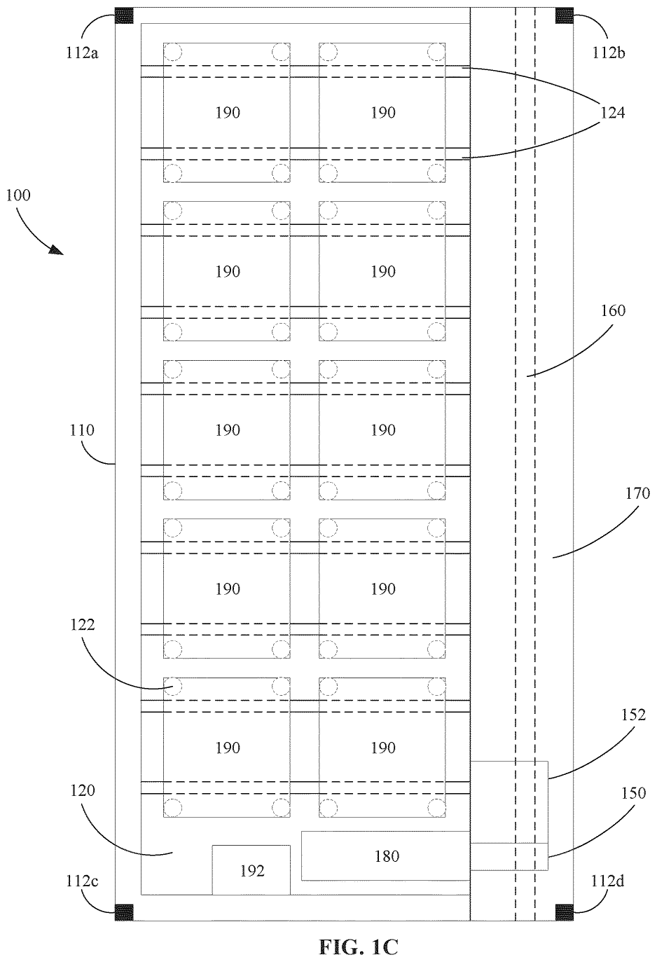

FIGS. 1A and 1B are block diagram illustrations of a top view and front elevation view, respectively, of an embodiment of a power module releasably mounted to a structure having a universal mounting element in accordance with the present disclosure. The power module 100 includes a mounting apparatus 110 for releasably mounting to a top surface of a shipping container 200. The mounting apparatus 110 may include a plurality of locking mechanisms 114 for releasably coupling with a universal mounting element of the shipping container 200, such as the top left mounting element 212a and top right mounting element 212b illustrated in FIG. 1B. In an embodiment, the universal mounting element complies with an internationally recognized or adopted standard, such as a standard issued by the International Organization for Standardization (ISO).

In an embodiment, the mounting apparatus 110 may comprise a steel border, wherein each corner of the mounting apparatus 110 comprises a respective mounting element 112a, 112b, 112c, and 112d for aligned with a corresponding universal mounting element of the shipping container 200. For example, as illustrated in FIG. 1B, a bottom left mounting element 112c of the mounting apparatus 110 is provided in a reciprocal location to the top left mounting element 212a of the shipping container 200, for supporting locking engagement therewith. Similarly, the bottom right mounting element 112d of the mounting apparatus 110 is provided in a reciprocal location to the top right mounting element 212b of the shipping container 200, for supporting locking engagement therewith. In an embodiment, the steel border is manufactured to a thickness of at least 4 inches.

In an embodiment, the reciprocal mounting elements 112a, 112b, 112c, and 112d of the mounting apparatus 110 may comprise an ISO corner casting. In an embodiment, the universal mounting element of the shipping container 200 comprises an ISO corner casting. In an embodiment the locking elements 114 may comprise a double ended locking element having a first locking end for coupling with a mounting element of the mounting apparatus 110 and a second locking end for coupling with a mounting element of the shipping container 200, for use in releasably coupling the mounting apparatus 110 to the shipping container 200. In an embodiment, the locking element 114 comprises a twist lock wherein a lever of the twist lock actuates the twist lock between locking engagement with, and open-release from, a mounting element. In an embodiment, the locking element 114 may be permanently fixed or incorporated into the mounting apparatus 110. In an embodiment, the mounting elements 112a, 112b, 112c, and 112d comprise a locking element 114. In an embodiment, the locking element 114 may include a processor and memory having instructions stored thereon that when executed by the processor, cause the locking element to change between locking engagement with, and open-release from, a mounting element.

The mounting apparatus 110 further includes a mounting frame 120 for securing a power supply, such as a solar power supply comprising a plurality of solar panels 190, within the mounting apparatus 110. The solar panels 190 may be attached to mounting locations on the mounting frame 120 in a permanent or non-permanent manner, such as may be accomplished using for example fasteners, adhesives, straps, and welding techniques. As illustrated in the embodiment of FIG. 1A, the mounting frame 120 includes a plurality of metal straps running beneath the solar panels 190 for mounting the solar panels 190 to the mounting frame 120. As further illustrated in the embodiment of FIG. 1A, the mounting frame 120 may include a plurality of grommets 122 provided on the mounting frame 120 and beneath the solar panels 190, for reducing vibration in the solar panels 190. In an embodiment, the grommets 122 comprise a rubber material. In the illustrated embodiment, the power module 100 includes ten solar panels 190 provided in a five-by-two arrangement, however, embodiments of a power module in accordance with the present disclosure may include a different number of solar panels in different arrangements. Embodiments of a power module 100 may include electrically coupling the solar panels 190 in series or in parallel.

In an embodiment, each solar panel is configured for providing an output of up to about 38.6 volts. The solar panels 190 may provide a DC output for coupling to an external system. For example, embodiments of a power module 100 in accordance with the present disclosure may include an electrical circuit for coupling the output of the solar panels 190 to a bus 160, further electrically coupled to an external system, such as a propulsion system being used to transport the shipping container 200 or an electrical system of the shipping container 200 itself. The bus 160 may be provided beneath a surface or a walkway portion 170 of the mounting apparatus 110. Embodiments of a power module 100 may not include a walkway portion 170 and may rather use the walkway portion 170 of the mounting apparatus 110 for other purposes, such as for additional power supply or other components.

Embodiments of a power module 100 in accordance with the present disclosure may include a bus 160. The bus 160 may be an AC or DC bus as may be required to couple the power module 100 to other systems and/or other power modules. In some embodiments, the power module 100 may couple to an external bus that does not form part of the power module. For example, the power module 100 may include additional circuitry to couple a power supply of the mounting apparatus 110 to a bus provided by, or attached to, an external system or structure. Embodiments of a power module 100 may further directly couple to an external system without need of a bus. A power module in accordance with the present disclosure may include a bus depending on, for example, the number of power modules to be coupled together and/or a proximity of the power module to the external system. Embodiments of an electric circuit for coupling the solar panels 190 to the bus 160 may include for example, an inverter 140 for providing an AC output based on a DC output of the solar panels, and a junction box 150 for enclosing further circuitry used to couple an output to the bus 160. In other embodiments, the DC output of the solar panels 190 may be provided to the bus 160 without conversion to AC.

FIG. 1C is a block diagram illustration of a top view of an embodiment of the power module 100 illustrated in FIG. 1A, wherein the electrical circuit coupled to the bus 160 includes a unidirectional DC-DC converter boost 180 and a junction box 150. The DC-DC converter boost 180 may receive a total output from the plurality of solar panels 190 and provide a further step up output. As an illustrative example, the DC-DC booster may receive an output from each of the ten solar panels 190 wherein an output of each solar panel is provided at 38.6 V. Accordingly, the booster may receive a 386 V output from the plurality of sonar panels 190, and may provide a further step up output based on the 386 V. In an embodiment, the DC-DC booster 190 provides a step up output of about 800 V.

One or more of the solar panels 190 may further include one or more elements for adjusting a disposition and/or an orientation of a solar panel, such as a pitch, roll, or rotation of the solar panel relative to the mounting apparatus. For example, one or more solar panels may include a first mechanical element (not illustrated) for pivoting or adjusting a pitch of the solar panel. For example, the mounting apparatus 110 may include an extendable arm pivotally coupled between the mounting frame 120 and the solar panel 190 wherein extending or retracting a length of the extendable arm pivots or adjusts a pitch of the solar panel relative to the mounting frame 120. One or more of the solar panels 190 may further include a second mechanical element (not illustrated) for rotating the solar panel relative the mounting frame 120. For example, the mounting apparatus 110 may include mounting the solar panel 190 to a turntable or rotatable platform which spins or adjusts a rotation of the solar panel relative to the mounting frame 120. Embodiments as disclosed herein include providing one or more solar panels with both a first and second mechanical element for adjusting both a pitch and rotation of the solar panel relative to the mounting frame 120. Embodiments as disclosed herein include providing one or more solar panels with a plurality of mechanical elements for adjusting an orientation of the solar panel. Advantageously, adjusting an orientation of a solar panel may improve the solar panel's exposure to sunlight. Embodiments of elements for adjusting an orientation of a solar panel are not so-limited to the aforementioned examples, and embodiments as disclosed herein may further include other mechanical elements and techniques known in the art.

Embodiments of a power module 100 may further include a solar tracker module 192 having one or more sensors for determining a position of the sun and providing a control signal for adjusting an orientation of a solar panel. For example, in an embodiment, the solar tracker module 192 may provide a first control signal for controlling a first mechanical element for adjusting a pitch of the solar panel, and may provide a second control signal for controlling a second mechanical element for adjusting a rotation of the solar panel. Accordingly, the solar tracker module 192 may provide one or more control signals for operating of one or more mechanical elements configured for adjusting an orientation of the solar panel. In an embodiment the solar tracker module provides a control signal for adjusting an orientation of the solar panel to minimize an angle of incidence between incoming sunlight and a surface of the solar panel. In an embodiment, the solar tracker module 192 may include a processor and memory having instructions stored thereon that when executed by the processor, cause the solar tracker module 192 to generate a control signal for adjusting an orientation of a solar panel.

Embodiments of a solar tracker module 192 may further comprise one or more collision detection sensors (not illustrated), disposed about the mounting apparatus 110. The collision detection sensors may be configured to detect a collision between a solar panel 190 and another object, such as another solar panel 190, the mounting frame 120, the mounting apparatus 110, and so forth. A solar tracker module 192 may thus incorporate sensor readings from the collision detection sensor(s) to modify or preempt a control signal from adjusting an orientation of a solar panel in manner which would cause a collision between the solar panel and another object.

Embodiments of a power module 100 may further include a power storage element 152, such as a rechargeable battery unit, for use in storing an output of the solar panels. The battery unit 152 may be electrically coupled to an output of the one or more solar panels 190, for use in receiving and storing a charge. In an embodiment, the battery unit 192 is a 12V battery. The battery unit 152 may be electrically coupled to one or more elements of the power module 100, to provide supplemental power thereto. For example, the battery unit 152 may be electrically coupled to provide power to the solar tracker module 192 and the mechanical elements it controls for adjusting an orientation of a solar panel 190, particularly when there is a lack of sunlight exposure. Similarly, the battery unit 152 may be electrically coupled to one or more locking mechanism 114, for use in actuating the locking mechanism 114 between a locked disposition and an unlocked disposition.

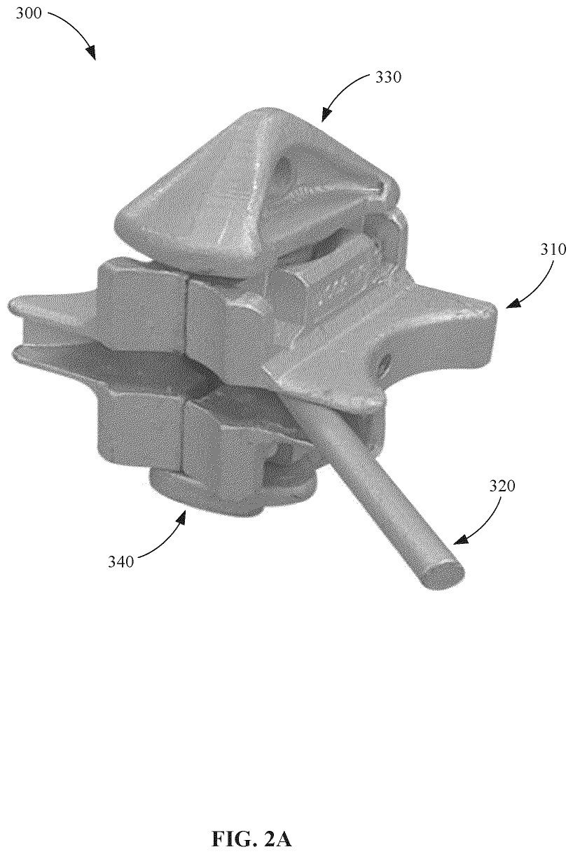

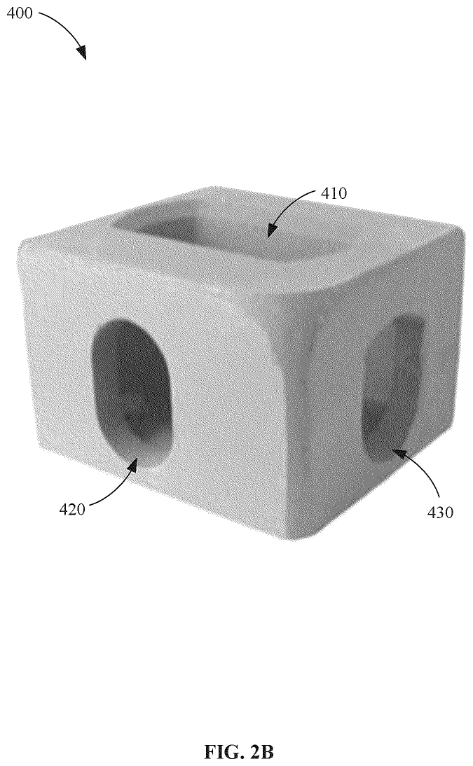

FIGS. 2A and 2B illustrates perspective views of a locking element and a universal mounting element, respectively, in accordance with an embodiment of the present disclosure. In particular FIG. 2A illustrates a double-ended locking mechanism 300 comprising a twist lock for coupling with first and second mounting elements, such as the mounting element 400 illustrated in FIG. 2B which comprises an ISO corner casting as may be found on a structure such as a shipping container.

In the illustrative embodiment of FIG. 2A the locking element 300 comprises a base 310 and lever 320 which actuates movement and/or rotation of a first locking end 330 and a second locking end 340. The base 310 of the locking element 300 may situate below and in contact with a locking element of a mounting apparatus; and, similarly above and in contact with a mounting element of a shipping container, as illustrated for example by the locking elements 140 in FIG. 1B which situates in between, and in contact with, the mounting apparatus 110 and the shipping container 200. Embodiments of a locking element in accordance with the present disclosure include providing a base 310 configured for supporting the mounting apparatus 110 based on a size, dimension, thickness, geometry, or material composition of the locking element 300.

The lockable ends 330 and 340 are sized and dimensioned for coupling with a respective mounting element. For example, the lockable ends 330 and 340 may be dimensioned for entering through an aperture, such as the aperture 410 of the universal mounting element 400. Once a locking end is disposed within an interior cavity of a universal mounting element 400, moving the lever 320 may actuate movement and/or rotation of a locking end into an interlock with an interior of the universal mounting element 400, whereby the locking end is disposed in a locked position which does not allow it to return back through the aperture 410 through which it entered, until rotated back to a release position.

Embodiments of a locking element 300 may include actuating movement and/or rotation of the locking elements concurrently together, or in separate stages. For example, the lever 320 may be moved from a release position to a first locked position to actuate movement and/or rotation of the first locking end 330 into a locking position with a first mounting element without causing movement of the second locking end 340. The lever may then be further moved from the first locked position to a second locked position to actuate rotation of the second locking end 340 into a locking position with a second mounting element. Similarly, the lever 320 may be moved back from the second locked position to the release position, to actuate rotation of the locking ends 330 and 340 from a locked position to a release position.

In the illustrative embodiment of FIG. 2B, the mounting element 400 comprises a universal mounting element, in particular an ISO corner casting as may be found on shipping containers throughout the world in accordance with an international standard. The mounting element 400 particularly illustrates a top left ISO corner casting having a plurality of apertures 410, 420, and 430, namely a first aperture 410 or stacking hole, a second aperture 420, and a third aperture 430. Typically, the stacking hole 410 may receive a fixture or component, such as a locking end of a locking element, into an interior of the mounting element; and, subsequently, disposition of the fixture or component is manipulated to bring it into locking engagement with the mounting element 400 to provide coupling between the locking element and the mounting element 400. The second 420 and third apertures 430 may provide similar utility for attachments and locking elements.

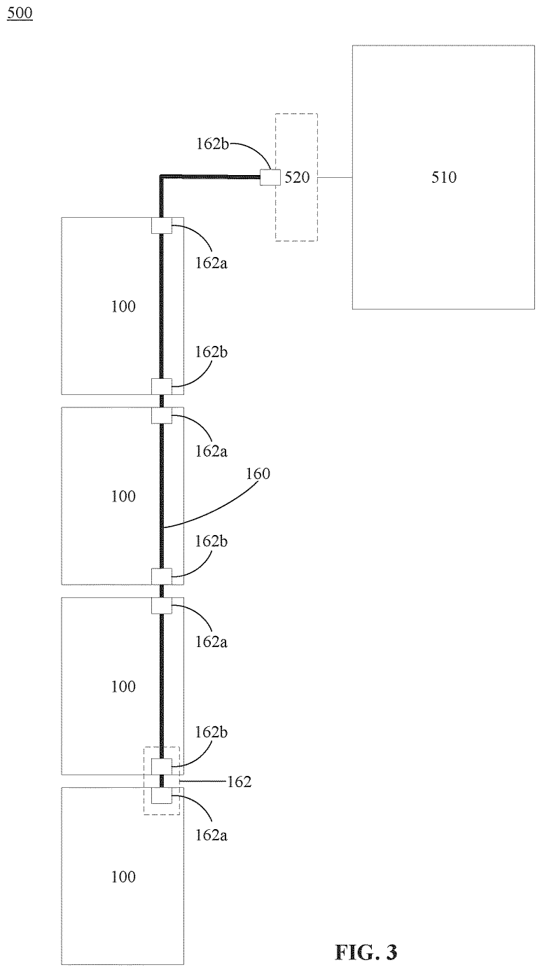

FIG. 3 is a block diagram illustration of a power module system in accordance with an embodiment of the present disclosure. The system 500 may be implemented across a plurality of structures, for example, across a plurality of shipping containers disposed in series on a rail train; or, for example, a plurality of shipping containers as may be provided on a cargo or shipping vessel or sitting at a port. The system 500 may include a power module for each shipping container, such as a power module 100 further detailed and illustrated with respect to FIGS. 1A-1C. The power modules 100 may be connected in parallel via a bus, such as the bus 160 further detailed and illustrated with respect to FIGS. 1A-1C. Embodiments of a bus 160 include an AC bus and a DC bus. The bus 160 may be coupled across the plurality of the power modules 100 using a plurality of connectors 162 comprising a first connecting element 162a and a second connecting element 162b. The first connecting element 162a may comprise, for example, a male connector, for reciprocal fitting with a fame receptor of the second connecting element 162b, or vice-versa. In an embodiment, the connector 162 comprises an automatic connector, such as, for example, a Staubli™ automatic rapid charging connector QCC. In such an embodiment, the first connecting element 162a, may include a probe for automatically detecting and connecting to a reciprocal element of the second connecting element 162b, or vice versa.

The bus 160 may couple the plurality of power modules 100 to an external system 510, such as propulsion system used in transporting the shipping containers. Embodiments of an external system 510 for which a modular power supply in accordance with the present disclosure may provide power to or for include, but are not limited to: auxiliary and standby generators, power-grids, marine propulsion systems, rail locomotives including battery-electrical rail vehicles, overland trucks, internal combustion engines (ICE), hybrid engines, and electrical and/or battery engines. Embodiments of modular power supply as disclosed herein may also serve as a source of power for a structure and its associated use, for example by providing power to a shipping container to support its use in providing shelter or housing. Embodiments of a modular power supply as disclosed herein may also act as a grid-tied element for supporting a power grid, such as a power grid at a shipping or port facility, or for example, for a micro-grid, an islanded micro-grid or non-islanded micro-grid.

The system 500 may further include additional elements, such as circuitry 520. Embodiments of circuitry 520 may include a DC/DC converter for stepping up or stepping down an output of the bus 160, to the external system 510.

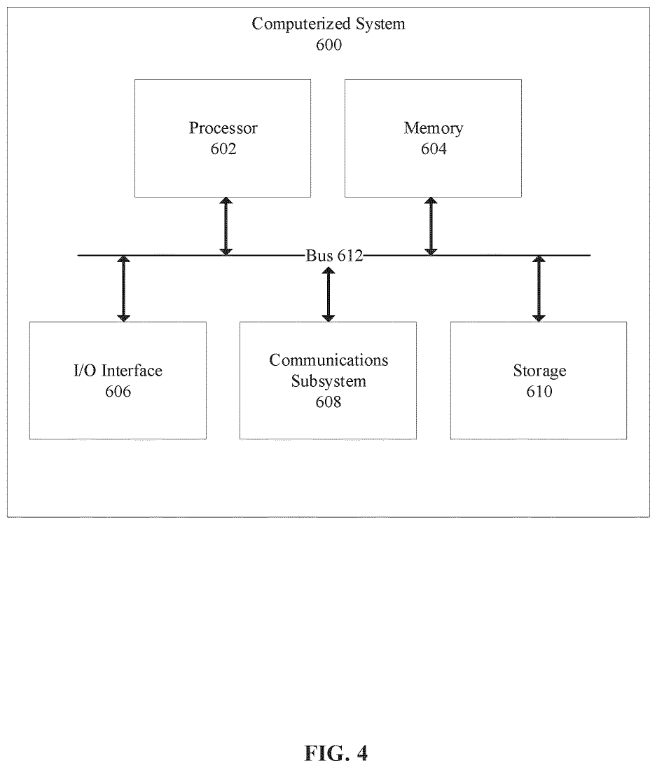

FIG. 4 is a block diagram of an example computerized device or system 600 that may be used in implementing one or more aspects, components, sub-components, operations, and so forth, of an embodiment of a power module in accordance with the present disclosure.

Computerized system 600 may include one or more of a processor 602, memory 604, a mass storage device 610, an input/output (I/O) interface 606, and a communications subsystem 608. Further, system 600 may comprise multiples, for example multiple processors 602, and/or multiple memories 604, etc. Processor 602 may comprise one or more of a digital processor, an analog processor, a digital circuit designed to process information, an analog circuit designed to process information, a state machine, and/or other mechanisms for electronically processing information. These processing units may be physically located within the same device, or the processor 602 may represent processing functionality of a plurality of devices operating in coordination. The processor 602 may be configured to execute modules by software; hardware; firmware; some combination of software, hardware, and/or firmware; and/or other mechanisms for configuring processing capabilities on the processor 602, or to otherwise perform the functionality attributed to the module and may include one or more physical processors during execution of processor readable instructions, the processor readable instructions, circuitry, hardware, storage media, or any other components.

One or more of the components or subsystems of computerized system 600 may be interconnected by way of one or more buses 612 or in any other suitable manner.

The bus 612 may be one or more of any type of several bus architectures including a memory bus, storage bus, memory controller bus, peripheral bus, or the like. The CPU 602 may comprise any type of electronic data processor. The memory 604 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The mass storage device 610 may comprise any type of storage device configured to store data, programs, and other information and to make the data, programs, and other information accessible via the bus 612. The mass storage device 610 may comprise one or more of a solid state drive, hard disk drive, a magnetic disk drive, an optical disk drive, or the like. In some embodiments, data, programs, or other information may be stored remotely, for example in the cloud. Computerized system 600 may send or receive information to the remote storage in any suitable way, including via communications subsystem 608 over a network or other data communication medium.

The I/O interface 606 may provide interfaces for enabling wired and/or wireless communications between computerized system 600 and one or more other devices or systems. For instance, I/O interface 606 may be used to communicatively couple with sensors, such as cameras or video cameras. Furthermore, additional or fewer interfaces may be utilized. For example, one or more serial interfaces such as Universal Serial Bus (USB) (not shown) may be provided.

Computerized system 600 may be used to configure, operate, control, monitor, sense, and/or adjust devices, systems, and/or methods according to the present disclosure.

A communications subsystem 608 may be provided for one or both of transmitting and receiving signals over any form or medium of digital data communication, including a communication network. Examples of communication networks include a local area network (LAN), a wide area network (WAN), an inter-network such as the Internet, and peer-to-peer networks such as ad hoc peer-to-peer networks. Communications subsystem 608 may include any component or collection of components for enabling communications over one or more wired and wireless interfaces. These interfaces may include but are not limited to USB, Ethernet (e.g. IEEE 802.3), high-definition multimedia interface (HDMI), Firewire™ (e.g. IEEE 1394), Thunderbolt™, WiFi™ (e.g. IEEE 802.11), WiMAX (e.g. IEEE 802.16), Bluetooth™, or Near-field communications (NFC), as well as GPRS, UMTS, LTE, LTE-A, and dedicated short range communication (DSRC). Communication subsystem 608 may include one or more ports or other components (not shown) for one or more wired connections. Additionally or alternatively, communication subsystem 608 may include one or more transmitters, receivers, and/or antenna elements (none of which are shown).

Computerized system 600 of FIG. 4 is merely an example and is not meant to be limiting. Various embodiments may utilize some or all of the components shown or described. Some embodiments may use other components not shown or described but known to persons skilled in the art.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A power module for mounting to a surface of a structure having a universal mounting element, the power module comprising:
a mounting apparatus having a frame for securing a solar power supply thereto, and
a locking mechanism configured for releasably coupling with the universal mounting element of the structure.

2. The power module of claim 1, wherein the solar power supply comprises a plurality of solar panels.

3. The power module of claim 2 further comprising an adjustable mechanical element for controlling an orientation of a solar panel, the mechanical element coupled to the frame of the mounting apparatus and a solar panel of the plurality of solar panels.

4. The power module of claim 3, wherein the mechanical element comprises a retractable arm pivotally mounted to the frame of the mounting apparatus, the retractable arm for adjusting a pitch of the solar panel relative to the frame of the mounting apparatus.

5. The power module of claim 3 or claim 4, wherein the mechanical element comprises a rotatable platform mounted to the frame of the mounting apparatus, the rotatable platform for adjusting a rotation of the solar panel relative to the frame of the mounting apparatus.

6. The power module of any one of claims 3 to 5 further comprising a solar tracker module for determining a position of the sun, the solar tracker module being configured to provide a control signal to to the mechanical element for adjusting the orientation of the solar panel.

7. The power module of claim 6 further comprising a collision detection sensor in communication with the solar tracker module, the collision detection sensor configured for determining whether adjusting the orientation of the solar panel will result in a collision with another object.

8. The power module of any one of claims 1 to 7, wherein the locking mechanism comprises a first locking element configured for releasably coupling with the universal mounting element of the structure.

9. The power module of any one of claims 1 to 8, wherein the mounting apparatus comprises a plurality of the locking mechanism for releasably coupling the mounting apparatus to a corresponding plurality of the universal mounting element of the shipping container.

10. The power module of claim 9, wherein the mounting apparatus comprises a plurality of mounting elements for attaching with the locking mechanism.

11. The power module of claim 9, wherein the plurality of mounting elements are disposed on the mounting apparatus for mounting alignment with a reciprocal universal mounting element.

12. The power module of any one of claims 1 to 11, wherein the locking mechanism comprises a second locking element for attaching the locking mechanism to the mounting apparatus.

13. The power module of any one of claims 1 to 12, wherein the locking mechanism comprises a lever for actuating the locking mechanism between a locked disposition and an unlocked disposition.

14. The power module of any one of claims 1 to 13, wherein the locking mechanism comprises a twist lock.

15. The power module of any one of claims 1 to 14, wherein the universal mounting element comprises an ISO corner casting.

16. The power module of any one of claims 1 to 15 further comprising an electrical circuit for coupling an output of the power supply to a bus electrically coupled to an electrical system.

17. The power module of claim 16, where the power module comprises the bus.

18. The power module of claim 16 or claim 17 wherein the bus comprises a DC bus and the power module further comprises a unidirectional DC-DC converter coupled between the output of the power supply and the bus, the converter for boosting the output of the power supply to the bus.

19. The power module of claim 16 or claim 17 wherein the bus comprises an AC bus and the power module further comprises an inverter coupled between the output of the power supply and the bus.

20. The power module of any one of claims 1-19 wherein the frame includes a plurality of rubber grommets in contact with the power supply for mitigating vibration.

21. The power module of any one of claims 16-20 wherein the structure comprises a shipping container.

22. The power module of claim 21 wherein the electrical system comprises a propulsion system for use in transporting the shipping container.

23. A modular power system for a plurality of structures, comprising:
a plurality of power modules in accordance with any one of claims 1 to 22 for mounting to the plurality of structures, and
a common bus for electrically coupling the plurality of power modules in parallel to an external electrical system of the plurality of structures.
